(19) United States
(12) Patent Application Publication
(10) Pub. No.: US 2005/0021352 A1
(43) Pub. Date: Jan. 27, 2005

(54) Sports club creation, management, and operation system and methods therefor

(76) Inventors: Ronald P. Maierhofer, Kingstowne, VA (US); David J. Pistell, Clifton, VA (US); Jack Permison, Ashburn, VA (US)

Correspondence Address: JAMES E. GOEPEL, Unit 202, 6603 Lawndale Drive, Falls Church, VA, 22042, US

(21) Appl. No.: 10/700,564

(22) Filed: Nov. 5, 2003

Related U.S. Application Data
(60) Provisional application No. 60/423,531, filed on Nov. 5, 2002.

(51) Int. Cl. G06F 17/60

(52) U.S. Cl. 705/1

(57) ABSTRACT

A turn-key, sports clubs club management and operation tool which automates many of the back-end club administrative processes, while at the same time providing advanced training aids, including a circle of masters, to club participants.

This application claims priority from Provisional U.S. Patent Application Ser. No. 60/423,531, filed Nov. 5, 2002, which is hereby incorporated by reference in its entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to the field of sports management, and more particularly provides a system and methods which simplify the creation, management, and operation of sports clubs.

### BACKGROUND OF THE INVENTION

The sports industry in the United States, and even in many foreign countries, is rapidly growing. From sports equipment for weekend-warrior, youth, and professional athletes, to tickets to professional sporting events, to athletic training, Americans continue to increase their discretionary spending on sports-related goods and services. Interestingly, the spending is not limited to traditional sports, like baseball, football, soccer, and the like, but even expands to less traditional sports like rock climbing, mountain biking, martial arts, lacrosse, track and field, and the like.

Some in the prior art have recognized the vast sporting market, especially with respect to sports training. For example, some in the prior art have created pre-recorded video or multimedia presentations, typically distributed on video cassettes or digital video discs (DVD's), which attempt to teach drills or sports tactics to players and coaches. Others, such as www.soccertutor.com and www.flashdrills.com, have begun to use the World Wide Web to distribute such training information, typically providing animated instructions for drills and other training activities. Some web sites offer message boards where coaches can post information for, and receive feedback from, other coaches.

As more people become interested and involved in sports, there is an increasing interest in competing against others interested in a particular sport. This typically results in periodic, regional level competitions among individuals and teams interested in that sport or a combination of related sports. However, despite the effort of some in the community, most sports cannot generate the kind of interest necessary to successfully establish and operate competitive sporting clubs, such as those associated with amateur football or baseball in the United States. This is typically because establishing, operating, and maintaining such clubs is time and resource intensive for the managers, and frequently they cannot find other people to take over or assist in management of the club. Another problem which hampers creation and long-term operation of sports clubs is finding and training coaches, referees, judges, and others involved in administration of the club.

Some, such as Acteva of San Francisco, Calif., have attempted to address the needs of sporting clubs by making membership management software designed for churches, community groups, and the like, available to sporting clubs. While such software can assist in managing member lists and tracking payment of membership funds, the software fails to address any of the other needs felt by sports clubs, such as team-level financial accounting, game and facility scheduling, player information management, coach and referee communications, and the like.

One company, SportsConnect of Nunawading, Victoria, Australia, has taken a different approach to meeting the needs of sporting clubs. SportsConnect has adapted workflow and process management software distributed by WordWare Pty Ltd of Nunawading, Victoria, Australia, for use by sporting clubs. SportsConnect's product is designed to improve club administration, comply with controlling bodies and government programs and requirements, and streamline communication between club managers. The SportsConnect product provides a structured, process-oriented approach to sports clubs management by generating step-by-step guides that walk various club administrators, coaches, and volunteers through the steps necessary to perform the tasks assigned to them by club administrators. The SportsConnect product also includes a training section to teach administrators, coaches, volunteers, and other users how to use the SportsConnect software and how specific tasks should be performed. Although the SportsConnect product simplifies administration of sporting clubs, the SportsConnect product fails to meet all of the needs of club administrators, including improving coach, referee, and player skills with respect to the game and its rules; allowing players, coaches, and referees to purchase equipment; and effectively managing club funds at the team level.

### SUMMARY OF THE INVENTION

Accordingly, the present invention is directed to a sports club creation, management, and operation system and methods therefore which substantially obviate one or more of the problems due to limitations and disadvantages of the related art. Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

The present invention provides a system and methods through which sports clubs can be easily created, managed, and operated. As used herein with respect to the present invention, the term sports club should be interpreted as including traditional sports clubs, sports leagues, sports associations, or individual teams acting as a sports club, league, or association. The present invention preferably allows a club manager to track club finances; maintain referee, player, coach, and team information; schedule practices and competitions; provide training to players, coaches, and referees; and perform other club-related functions. A preferred embodiment of the present invention also allows users, including players, coaches, and referees, to communicate with one another using instant messaging, chat rooms, video conferencing, discussion forums, and the like; and to share training, practice, and other such information. Coaches may also access and manage team-specific information, such as, but not limited to, player names, team finances, and the like. Still further, the present invention preferably allows players, coaches, and referees to purchase equipment appropriate to the sport.

A preferred embodiment of the present invention is implemented using a client/server based architecture, with the client preferably implemented as a native application which runs on a user's computer. The server is preferably a LINUX® or Microsoft Windows® server capable of providing the various features described herein. Although a preferred implementation of the present invention is described herein, it should be apparent to one skilled in the art that alternative operating systems, architectures, and the like may be substituted therefore without departing from the spirit or the scope of the present invention. By way of example, without intending to limit the present invention, although a native application is presently preferred, the client-side software can also be implemented in a JAVA-based applet or series of applets, one or more Macromedia Flash® based applications, or as a series of HTML or XML pages. Still further, although the implementation described herein focuses on users with desktop or laptop computers, it should be apparent to one skilled in the art that additional computing devices, including, but not limited to, pagers, cellular telephones, portable desktop assistants, and the like can be substituted therefor without departing from the spirit or the scope of the invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of at least one embodiment of the invention.

In the drawings:

FIG. 1 is a flow chart illustrating a preferred user login method.

FIG. 2 is a block diagram illustrating a preferred architecture through which the present invention can be deployed.

FIG. 3 is a screen capture of a preferred native application user interface.

FIG. 4 is a screen capture of a preferred instant messenger user interface.

FIG. 5 is a preferred E-mail login user interface.

FIG. 6 is a table of modules preferable available to referees utilizing the present invention.

FIG. 7 is a table of modules preferably available to players utilizing the present invention.

FIG. 8 is a table of modules preferably available to coaches utilizing the present invention.

FIG. 9 is a table of modules preferably available to administrators utilizing the present invention.

### DETAILED DESCRIPTION OF THE PREFERRED EMBODIMENT

Reference will now be made in detail to the preferred embodiments of the present invention, examples of which are illustrated in the accompanying drawings. Attached hereto, provides additional definitions and clarification of some of the features and functions available in an alternative embodiment of the present invention.

The present invention began as an online training tool through which individuals could seek advice from professionals or quasi-professionals with respect to a specific sport. As described in the above-referenced U.S. Provisional Patent Application, inter alia, the concept allowed individuals, and more particularly youths participating in a specific sport, such as soccer, to seek training advice from a “circle of masters”, comprised of current and/or former professional or collegiate coaches, professional or collegiate players, and the like. In one embodiment, the individuals could communicate with the circle of masters using videoconferencing, thereby allowing the master or masters with whom the individual was communicating to observe the individual as they performed training drills or other tasks requested by the master or masters, and vice-versa. The individual could thereby obtain individualized, high-caliber advice from experts in the sport, without having to travel to the master, or incur other such expenses.

As the concept developed, a need was perceived for a more comprehensive approach to sports clubs generally. It was recognized that many attempts to create sports clubs failed after a short period of time, if they ever got off the ground. Several reasons were identified as causing the sports club failures, including, but not limited to, poor financial planning; failure to leverage sponsorship opportunities; significant time requirements associated with running the sports clubs; and the limited availability of qualified coaches and referees.

The invention was therefore adapted to fill this much larger need. In addition to providing individuals, including coaches, players, and referees, with access to a circle of masters and other training resources appropriate to the individual's role in the club, the present invention also provides sports club administrators with a powerful set of tools to aid in the operation of the sports club.

The present invention preferably supports a plurality of user types, with different user types having different access rights and privileges to the various components that comprise the present invention. By default, the present invention defines four user types, or groups: players, coaches, referees, and administrators. Access privileges and rights can preferably be configured on a user-by-user basis and on a group-by-group basis. To encourage consistent use of groups and access privileges, the present invention preferably allows users to only belong to a single group. Individual-specific privileges and access rights preferably take priority over group-level access rights and privileges. Thus, in the event a group-defined privilege or access right excludes a user from accessing a particular function or feature of the present invention, but the user has been granted individual rights to access the function or feature, the user will be granted access thereto.

By default, the user who initially configures the present invention for use by a given club is granted administrator rights. Administrators are typically those running the operations of the club, and are given the highest level of access privileges, including the ability to define access rights and privileges for other users, define new groups, add and remove users, and the like.

When deployed, the present invention preferably allows users to enroll in a club by filling out a web-based interface. By default, such users are initially configured as members of the players group. Players typically have the lowest level access rights and privileges. Players can view and edit player-specific information, such as their contact information, and can view team-level information, such as practice times, competition schedules, and the like, but by default players cannot change team-level information. By default, players can also preferably view some information about other teams, such as injury reports, as well as club level information, such as team rankings and the like.

Once a player has enrolled, an administrator can change the player's access rights and privileges. Administrators can assign a player a new role by assigning the player to a different group. By way of example, an administrator can assign a player to the coach group. By default, coaches can view and edit team-level information and player-specific information for those players who are members of the coach's team. Coaches can also review club level information, such as team rankings, and information about other teams and their players.

Users can also be assigned a role as referee. By default, referees can view and edit referee-specific information, can access referee-specific resources, can view competition schedules, and can enter competition-specific information, such as, but not limited to, penalties, points scored, injuries, and the like at the end of a game. Referees can also review team-level information and player-specific information, but referees cannot edit such information.

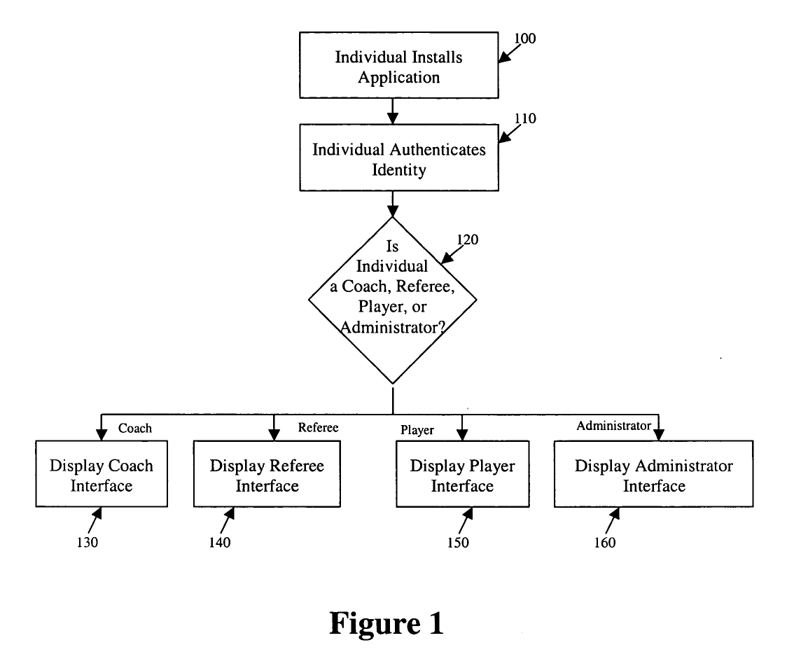

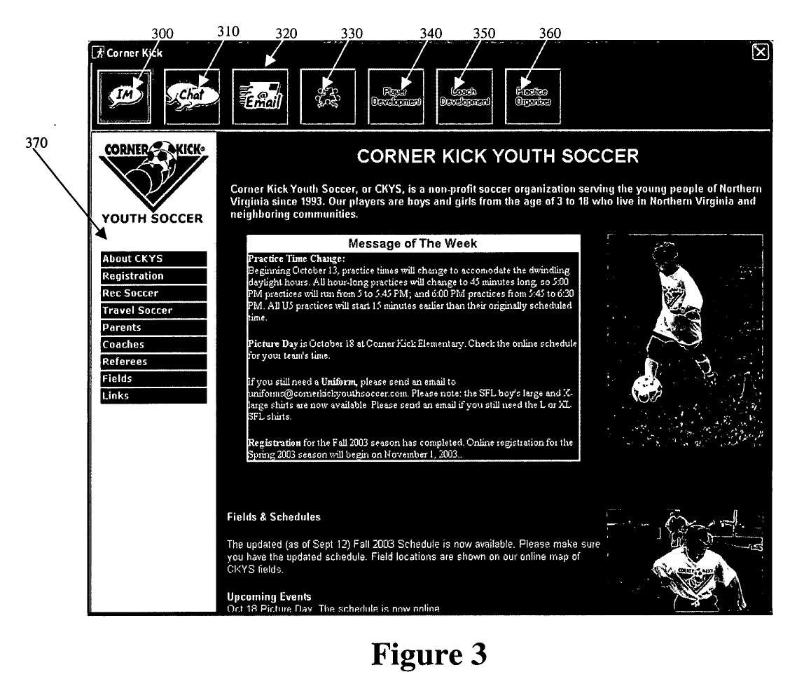

As FIG. 1 illustrates, once a user has registered with the system, the player preferably installs a custom-developed user interface application 100. The custom-developed user interface application is preferably similar to that illustrated in FIG. 3. The custom-developed user interface application is preferably a native application specific to the operating system used by the user. Although a native application is presently preferred, it should be apparent to one skilled in the art that an alternative user interface, such as, but not limited to, interfaces created using HTML, XML, JAVA, Macromedia's Flash® language, or combinations thereof, can be substituted for the native application without departing from the spirit or the scope of the invention.

As FIG. 1 illustrates, users preferably identify themselves to the system of the present invention using a login process 110. The login process preferably includes the user supplying a unique username and password combination to the system. The present invention also preferably allows users to identify themselves using biometric or other identifiers as part of the login procedure. The user-supplied login information is compared to a database of user information stored as part of the system of the present invention (Block 120). If the user supplies appropriate login information, the system of the present invention preferably provides an access privileges and rights report for the user to the native application. In one embodiment, the native application may load a user interface appropriate to the group to which the user belongs (Blocks 130 to 160). In an alternative embodiment, the user interface may be custom generated based on the access privileges and rights report, thereby hiding those features to which the user does not have access.

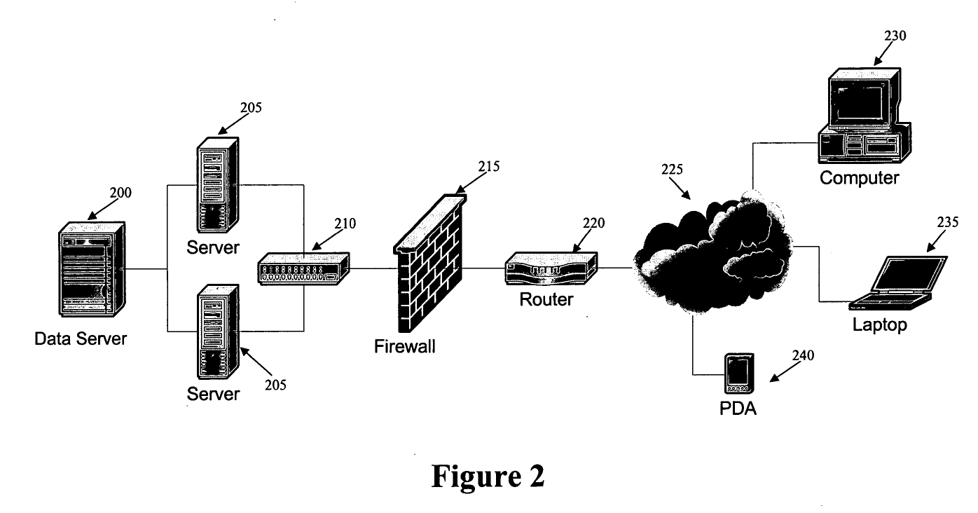

FIG. 2 is a block diagram of a preferred network architecture for implementing the present invention. It should be apparent to one skilled in the art that although the architecture of FIG. 2 is presently preferred, alternative architectures can be substituted therefor without departing from the spirit or the scope of the invention.

As FIG. 2 illustrates, users preferably access system 200 from an Internet-accessible computer. Such computers may take the form of traditional desktop computers 250, laptop computers 235, portable desktop assistants 240, cellular telephones, or other wireless or wired communications devices capable of communicating across Internet 230 or other communication means. System 200 is preferably connected to Internet 230 via at least one router 225. To enhance overall system security, a firewall 220 can be implemented between router 225 and the remainder of system 200. Firewall 220 preferably blocks all traffic to system 200 from Internet 230 based on the Transmission Control Protocol (TCP) or Unacknowledged Datagram Protocol (UDP) port associated with the traffic, or the functional equivalents thereof if other networking protocols are used. All traffic is preferably blocked by firewall 220, except traffic that which is occurring on authorized ports.

Firewall 220 may also require the use of valid digital signatures and/or encryption on some or all incoming traffic to further enforce security. In such an embodiment, custom-developed user interface application 100 of FIG. 1 may handle digitally signing and/or encrypting traffic between the user interface application and system 200, such that the process is effectively transparent to the user.

Incoming traffic which is not filtered out by firewall 200 may pass through one or more load balancers or switches 215 before being directed to one of servers 210. In the embodiment illustrated in FIG. 2, servers 210 are implemented using a redundant architecture, such that in the event one of the illustrated servers 210 ceases to operate, the traffic to that server may be redirected by load balancer 215 to the other server 210 until the non-operational server is back in operation.

Incoming traffic is preferably processed by one of servers 210, and servers 210 can communicate with data server 205 to retrieve data stored as part of the present invention to serve any requests associated with the incoming traffic. Prior to retrieving substantive data from, or writing data to, data server 205, server 210 preferably verifies that the user accessing or writing the data has rights to do so. This can be verified by performing a simple look-up query against data server 205.

Because of data replication issues associated with maintaining multiple copies of databases using current technology, and the cost associated with maintaining multiple data servers, the present invention preferably utilizes a single data server 205 to store information associated with the present invention, including, but not limited to, user-specific information, team-level information, and club information. Data server 205 is preferably implemented using a redundant array of independent disks (RAID array), and preferably uses both striping and parity (RAID 5). Each disk within the RAID array is preferably hot-swappable, and the RAID array preferably has redundant power supplies. This data server implementation provides a robust, fault tolerant data server while avoiding the problems associated with replicating data across multiple data servers. Although this data server implementation is preferred, it should be apparent to one skilled in the art that alternative architectures may be substituted therefor without departing from the spirit or the scope of the invention.

Information stored on data server 205, including, but not limited to, club-related information, team-specific information, and user-specific information, is preferably stored in an indexed, relational database. Creation of such databases is well known in the art.

Once servers 210 have retrieved any information necessary to meet the request posed by the incoming traffic, server 210 can send the information back to a user via Internet 230.

As described above with respect to FIG. 1, when a user interacts with the system of the present invention, the user preferably does so through a native application running on the user's computer. FIG. 3 illustrates a preferred user interface to such an application when implemented on a traditional laptop or desktop computer. As FIG. 3 illustrates, users can be presented with a toolbar of available features, such as, but not limited to, instant messaging 300, chat rooms 310, E-mail 320, video conferencing and/or a circle of masters 330, and training resources 340 through 360. Where a user does not have access to a specific feature or function, the native application preferably hides the existence of that feature or function from the user.

Although the description of the present invention focuses on the features and functions that are specific to a user's role within the club, such as managing finances, accessing training resources, chatting with referees, and the like, it should be apparent to one skilled in the art that the present invention can also include a great deal of information that is shared among users, as illustrated in region 370 of FIG. 3. By way of example, without intending to limit the present invention, all users may have access to a list of addresses and directions to playing fields, coach contact information, and the like.

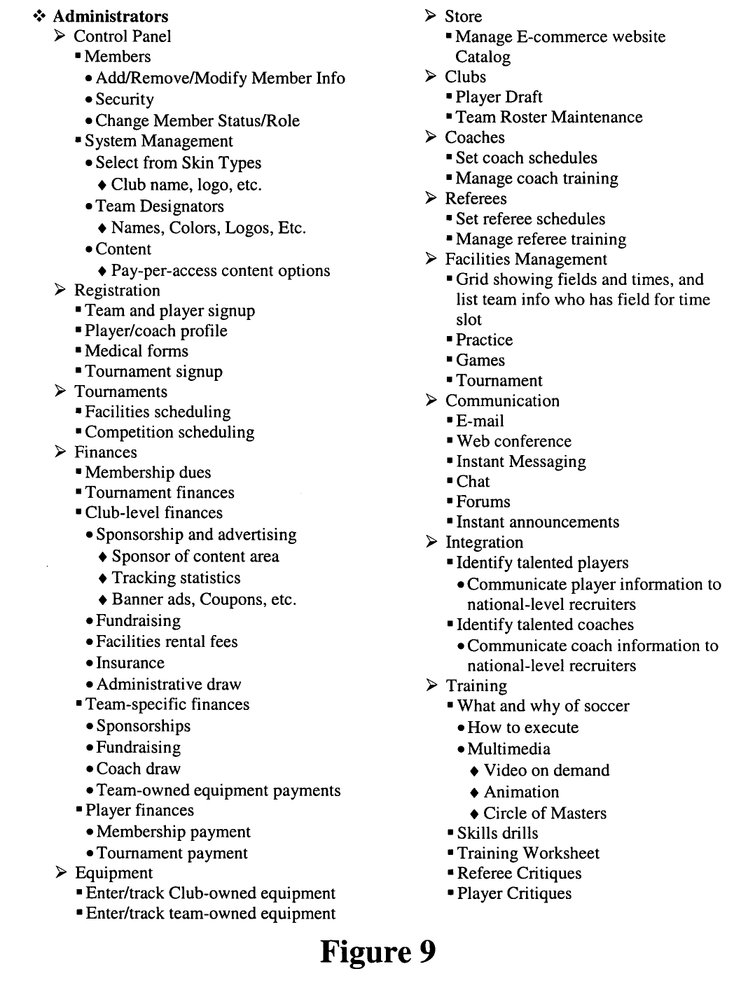

Referring to FIG. 9, an administrator who is authenticated by the system of the present invention preferably has access to the greatest number of features and functions of the system. The features and functions are preferably implemented in a modular approach, and the architecture of the native application preferably permits new modules to be easily added as new features and functions are made available.

An administrator preferably has the ability to access to all features and functions of the present invention, including, but not limited to, a control panel module, a registration module, a finance module, a communications module, and a training module. The control panel module preferably allows administrators to manage system information, such as, but not limited to, user-specific information, including user group membership, and the like. The control panel module also preferably allows administrators to define tasks and the processes associated therewith, and to delegate one or more tasks to specific users. Defined tasks can also be associated with specific events within the system, such as the scheduling of a new game. By way of example, without intending to limit the present invention, when an administrator initially configures the system, he or she may indicate that for each game played, referees are to enter specific information, such as game duration, player injuries, player penalties, and the like. Similarly, the administrator may indicate that for each reported player injury, the coach of the team to which the player is assigned must update the player's status every three days until the player is marked as healthy. The responsibilities associated with such tasks are preferably reported to a user as part of the user interface in the native application. By automating such business processes, the present invention can streamline club operations, distribute and store institutional knowledge, and can simplify the administrative burden associated with operating a club.

The control panel module also preferably allows administrators to configure team-specific information, such as display defaults; to enter team names, coaching assignments, player assignments, and the like; and to specify whether players, coaches, and referees are to be granted access to any pay-per-access content, and if so, how such content is to be paid for. Display defaults configurable by an administrator can include, but are not limited to, a default “skin”, or user interface orientation, club name, club colors, team colors, team logos, and the like. Such display defaults can be used in the generation of user interfaces by the native application such that each user sees what appears to be a privately-labeled user interface. By way of example, without intending to limit the present invention, a player for the Arlington CornerKicks may be presented with a user interface that utilizes a medium green as the main color with bright yellow accents, and an appropriate team logo. A player for the Falls Church Strikers, on the other hand, may be presented with a user interface that utilizes a bright red as the main color, with black accents and an appropriate team logo. The arrangement of elements within the user interface presented by the native application may also vary on a team-by-team or club-by-club basis.

When utilized by an administrator, the registration module preferably allows the administrator to review and edit individual-specific information, including, but not limited to, a list of users who are to be blocked from the club (i.e. those who have been banned for some reason); user profile information, such as contact information, age, sex, team assignments, medical history, and the like; and users who have signed up to participate in tournaments.

The finance module preferably allows an administrator to manage club finances. The tools available through the finance module are preferably similar to those found in traditional accounting software, such as QuickBooks™, sold by Quicken, Inc., including, but not limited to, tracking and payment of recurring bills, such as insurance, facilities rentals, and the like, as well as paying administrators, coaches, referees, and other users where appropriate.

One aspect of the finance module that may be slightly different from traditional accounting tools is that the finance module preferably includes the ability to create “sub-accounts” for each team within the club. This allows individual teams to hold team-specific fundraisers and the like and to manage and track those funds separately from the remainder of the club. In a preferred embodiment, funds to be dispersed from a team-specific sub-account may require administrator approval prior to being dispersed. Alternatively, approval by three coaches, including the team's coach, may be required before funds are dispersed from a team-specific sub-account.

Another aspect of the finance module that may differ from traditional accounting software is the ability to automatically track and bill sponsors and advertisers for banner ads, coupon placement, and the like. An administrator can indicate whether and how funds raised by such activities are to be distributed, including, but not limited to, directly to individual team sub-accounts based on revenues generated by that team, only to the club account, or split in a pre-defined ratio between the club account and the team sub-accounts.

The finance module also preferably tracks player membership and tournament payments. Such tracking may be performed automatically, with players notified via E-mail, pop-up instant announcements as the player logs into the system, or the like as they come due. Administrators can thus automatically view membership statistics, track delinquent users, and perform other such financial tracking functions.

The finance module can make the information contained therein available to an administrator through a variety of means. By way of example, without intending to limit the present invention, the finance module can make tournament financial information available through a top level user interface element, and can also make it available through a multi-tier menu system.

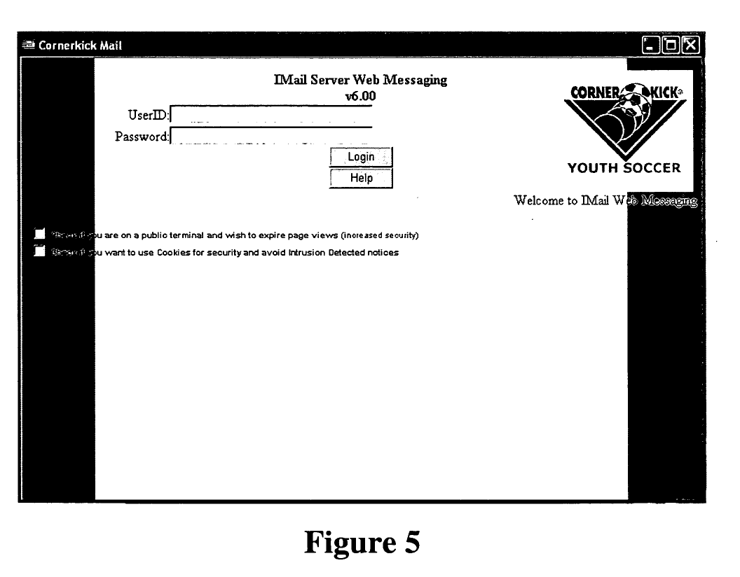

The communication module preferably facilitates communication between users through a variety of means, including, but not limited to, E-mail, web conferences, video conferences, instant messaging, chat, and instant announcements. In a preferred embodiment, the communications module may make E-mail accessible both through the native application and through a web-based E-mail user interface, such as those provided by ArGo Software and SendMail in their SMTP-based E-mail servers. FIG. 5 is a screen capture of a sample login screen associated with such a web-based E-mail interface.

Web conferences may be facilitated through standard conferencing applications, such as, but not limited to, Microsoft NetMeeting. Web conferences preferably include the ability to communicate via both voice and text-based messaging. Web conferences also preferably allow users to share a whiteboard or other drawing tool. Web conferences may further include the ability to cause video to be displayed on a remote computer, thereby facilitating video conferencing, and the display of alternative video while web conferencing.

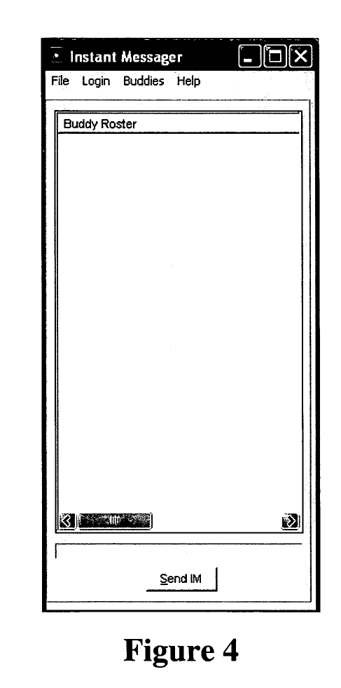

As implemented in the present invention, instant messaging is preferably limited to users of the system, and may even be limited to those in the same club, or on the same team. In alternative embodiment, instant messaging may be permit users of the present invention to communicate with users of other instant messaging software such as, but not limited to, ICQ and AOL Instant Messenger, distributed by America Online, Inc., and Yahoo! Messenger, distributed by Yahoo, Inc. FIG. 4 illustrates a sample Instant Messaging “buddy-list” user interface. Such a user interface allows a user to select the person with whom the user wishes to communicate (i.e. their “buddy”) and to send them an initial message. A separate window may then appear in which the buddies can exchange messages.

A preferred embodiment of the present invention also allows users to create one or more “chat rooms”, in which a plurality of users sharing a common interest can exchange messages in near real time. This is preferably implemented using the Internet Relay Chat (IRC) protocol as set forth in Internet Request for Comments numbers 1459, 2810, 2811, 2812, and 2813. Each club may have one or more parent chat rooms, to which all users assigned to that club have access. A club administrator may allow users to create sub-rooms within a parent chat room based on interest, or a club administrator may limit the chat rooms to a particular architecture, such as individual sub-room for each team in the club. A club administrator can preferably set access permissions on each chat room, such that members of rival teams cannot access a room without authorization.

An embodiment of the present invention may also implement one or more discussion forums, or bulletin boards, through which users can exchange messages. Discussion forums are useful for communications which do not require an immediate response, such as informational notices, general questions, and the like. Discussion forums can be created using a variety of software which runs on a server of the present invention, including, but not limited to, ZeroForum, distributed by RelyNet of Rancho Cardova, Calif.; and Phorum, distributed by the Phorum Project.

Instant announcements preferably allow an administrator to cause a dialog box or other display to be presented to users as they log into the system. Alternatively, if the user is logged into the system when the message is sent, the message can be instantly displayed. Instant announcements created by an administrator can be sent to all users in the club, users in a specific group, users associated with a specific team, or the like.

Instant announcements may be created using several different architectures. In one embodiment, the native application can periodically poll the server to determine if a new instant announcement is awaiting delivery to the currently logged in user. Alternatively, the native application may open one or more TCP/UDP ports for listening for an announcement from the server that such a message is available, and the native application can then retrieve the message from the server. In still another embodiment, if the native application is monitoring one or more TCP/UDP ports, the server may send the instant announcement directly to the native application. In the later two embodiments, the server may record the IP address of the user as the user logs in, thereby facilitating such messaging.

The training module preferably provides users with access to the variety of role-specific educational aids described above. Administrators preferably have the ability to access all educational aids stored within the system. Other users may be limited to viewing only those educational aids associated with the role performed by the user or group to which the user is assigned.

As described above, the educational aids can take a variety of forms. By way of example, without intending to limit the present invention, animated tutorials may be available to illustrate a drill which a coach can have his or her players perform. Video of a player performing a specific move may also be available to assist coaches and players with understanding how a specific move is to be executed. Such animation and video may be provided via the Internet, or the native application may access such information from a CD-ROM, Digital Versatile Disc (DVD), or other such local storage medium.

Where users still have difficulty understanding execution of a move, the users can turn to educational chat rooms and web conferences implemented as part of the present invention and in conjunction with the communications module for assistance from other users. The present invention can also allow a user to communicate with one or more members of a circle of masters where additional assistance is needed. The circle of masters is a collection of experienced players, coaches, and the like who are available to assist users with sports-related training. A preferred embodiment of the present invention preferably implements access to the circle of masters as a pay-per-access video conference, where the user is charged some fee to access the circle of masters. By way of example, without intending to limit the present invention, users may be charged per minute to speak with one or more members of the circle of masters. Although a video conference is presently preferred, it should be apparent to one skilled in the art that alternative communications means can also be leveraged by the present invention. By way of example, without intending to limit the present invention, a user may communicate with a member of the circle of masters by way of a Voice-over-IP conversation.

In addition to the core process management and training features and functions described above, the present invention also preferably makes an E-commerce web site available to administrators. Operators of the present invention can preferably partner with one or more sporting goods suppliers to make a catalog of equipment and supplies available to users. By leveraging the buying power of a collection of clubs, operators of the present invention may be able to negotiate significant price discounts for sporting goods sold through the E-commerce web site. An administrator can then be given the option to add a mark-up percentage or flat per-item fee for each item sold through the club's E-commerce web site. Alternatively, operators of the present invention may pay the club a fixed percentage of sales revenue generated through the club's E-commerce web site. Funds raised through the E-commerce web site may be distributed as specified by the Administrator in the finance module. In a preferred embodiment, coaches, referees, and other users may be encouraged to purchase equipment and supplies for the club through the E-commerce site.

The present invention can also preferably track team-owned and club-owned equipment via an equipment module. As such assets are acquired by the club, information about the asset is preferably entered into the present invention to facilitate tracking. A bar code, Radio Frequency Identification (RFID) or other asset tag may also be affixed to the asset to facilitate tracking. The database portion of the present invention can track to whom the asset has been assigned, thereby allowing for asset accountability. In addition, the equipment module may allow users to request access to a specific asset. Where an asset is owned by a team of which a player is not a member, the player may not be made aware that such an asset exists.

The present invention also preferably automates several club management tasks. By way of example, without intending to limit the present invention, for those clubs which permit player drafts, the present invention can prove an electronic interface for facilitating such drafts. Player statistics from previous seasons can be made available to coaches or other team managers prior to the draft to facilitate rapid player drafting. The draft is preferably implemented with each team's draft order determined by lottery.

The present invention can also automate team roster maintenance by monitoring player injuries and other such information. Administrators can also move players from one position to another in a given player roster and make other such adjustments.

Another preferred aspect of the present invention is the ability to automatically schedule facilities for practice and competitions. The present invention may permit an administrator and/or individual coaches to enter restrictions on coaching time, and the present invention will attempt to match team practice schedules to coach availability. By way of example, without intending to limit the present invention, coaches may enter their work schedule and indicate a preference as to morning or evening practices, and the present invention can attempt to schedule practice times in accordance to coach preferences. A similar scheduling technique may be used to schedule referees at the various tournaments and other competitions.

Administrators can preferably view schedule information in calendar and list formats. In one embodiment, the present invention can allow an administrator to select from a list of available facilities, and the schedule for that facility can be displayed, including any team practice sessions and/or competitions scheduled for the facility. Administrators can also preferably display schedules by team, by referee, and by tournament.

A preferred embodiment of the present invention also includes an integration module. An integration module is software that preferably runs on the server which monitors player statistics and identifies talented players. In a preferred embodiment, operators of the present invention may allow talent scouts to review privacy-compliant user statistics, and can facilitate communication between the talent scouts and the users. By way of example, without intending to limit the present invention, a coach may have several successive winning seasons, and although the coach's team never wins a championship, the coach may be of interest to a college or professional team. The talent scout may be notified of the coach's record and other statistical information. In the event the talent scout is interested in discussing other coaching options with the coach, the talent scout can have the present invention send an E-mail to the coach which includes the talent scout's contact information.

As described above, the present invention preferably allows an administrator to define and delegate one or more tasks to individual users. Where a delegated task requires access to information to which the user does not currently have permissions, the present invention may display a dialog box to the administrator making the delegation which gives the administrator the option of canceling the delegation or providing the user the requisite level of access on a temporary basis until the task is completed. Delegated tasks preferably have a due date assigned to them, and the temporary access privileges granted to the user can be revoked by the present invention as of that date in the event the user has not completed the task by that date.

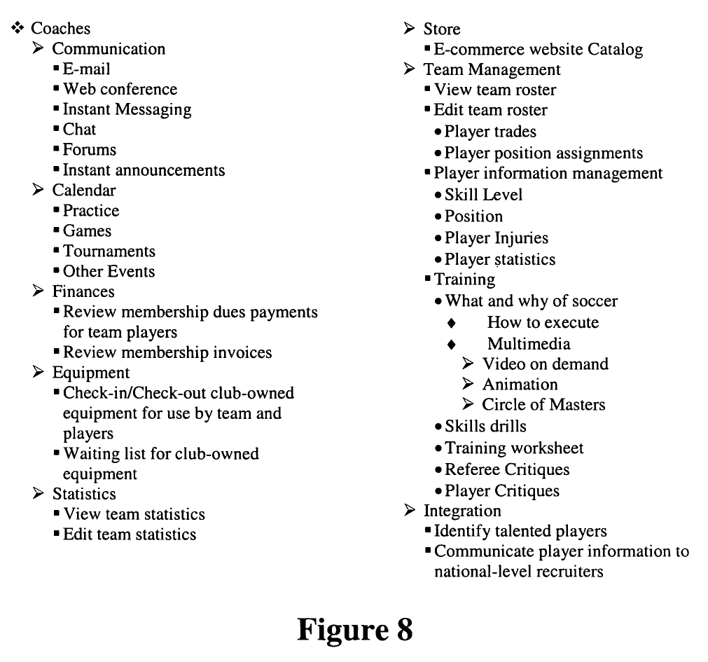

The modular features and functions available by default to coaches are illustrated in FIG. 8. In a preferred embodiment, a coach may serve as an administrator-like user with respect to the coach's team. A coach preferably has full privileges for team-related information, including accessing and changing user profiles for all users assigned to the coach's team and reviewing team finances. Coaches preferably do not have access to information regarding other teams except that which is made available to all users, such as injury reports, statistics, and the like.

Separate chat rooms and forums may also be available to coaches to facilitate coach training and communication. By way of example, without intending to limit the present invention, a coach may post a request to a coach forum requesting assistance on a given day when a complex drill will be run.

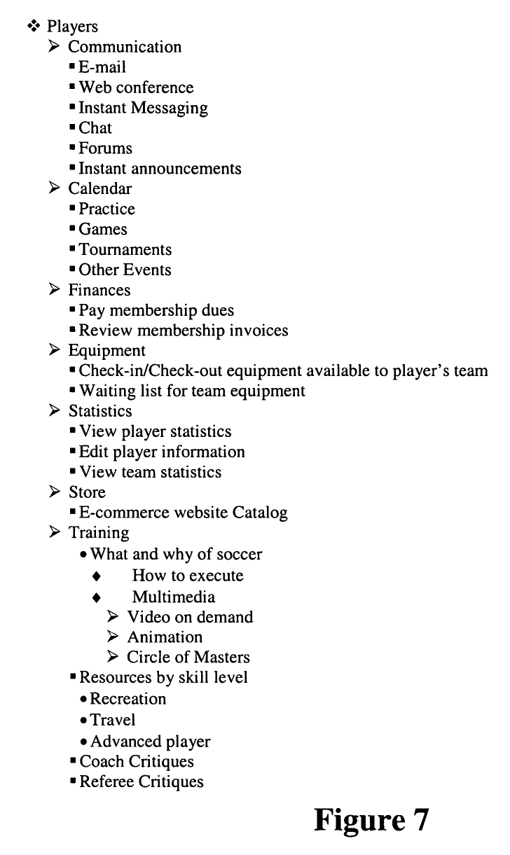

The modular features and functions available by default to players are illustrated in FIG. 7. In a preferred embodiment, players have the lowest level of access control. Players can preferably review and edit personal player information, such as name, address, telephone number, and the like. However, players may not edit player statistics. Players also preferably cannot view team or club financial information, although players may view and pay membership due invoices or the like.

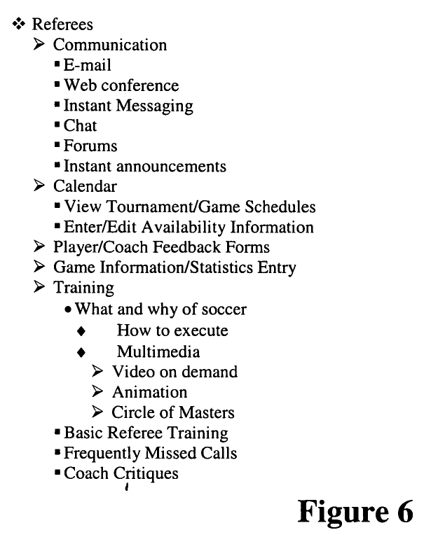

By default, referees have access to only a limited number of features and functions of the present invention because their duties do not require access to the other features. This is illustrated by the preferred referee module table of FIG. 6.

By utilizing combinations of the features and functions described herein, the present invention can be used to create a turn-key club management tool which automates many of the back-end club administrative processes, while at the same time providing advanced training aids, including a circle of masters, to club participants.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

1. A sports club management system comprising:
a control panel, wherein the control panel allows at least one administrator to configure settings including at least one sports club name;
a registration module, wherein the registration module obtains information from a plurality of users;
an authentication module, wherein the authentication module permits the at least one administrator and the plurality of users to individually identify themselves to the sports club management system;
a user information storage means, wherein the user information storage means stores the information obtained through the registration module;
a communications module, wherein the communications module permits the at least one administrator and the plurality of users to communicate;
a finance module, wherein the finance module tracks club financial information, including payment of sports club membership fees by at least one of the plurality of users; and
a training module, wherein the training module provides educational information to at least the plurality of users with respect to at least one sport.

2. The sports club management system of claim 1, wherein the control panel further allows the at least one administrator to define and enter information about a plurality of teams to be a part of the sports club, and wherein information about the plurality of teams is stored in a team information storage means.

3. The sports club management system of claim 2, further comprising a scheduling module, wherein the scheduling module allows the at least one administrator to schedule competitions between at least two of the plurality of teams.

4. The sports club management system of claim 2, further comprising a team membership maintenance module, wherein the team membership maintenance module allows the at least one administrator to define which of the plurality of users is assigned to the plurality of teams.

5. The sports club management system of claim 4, wherein the control panel further permits the at least one administrator to designate at least one user from the plurality of users to serve as coach of each of the at least one teams.

6. The sports club management system of claim 5, wherein the at least one coach can utilize the team membership maintenance module to define which of the plurality of users is assigned to a team.

7. The sports club management system of claim 5, wherein the communications module permits the at least one coach to communicate with the plurality of users assigned to the coach's team.

8. The sports club management system of claim 1, wherein the player information includes player injury information and player statistics.

9. The sports club management system of claim 1, wherein the training module provides the plurality of users with access to members of a circle of masters.

10. The sports club management system of claim 9, wherein the communications module includes a video transmission component.

11. The sports club management system of claim 10, wherein the training module integrates with the communications module to permit a member of the circle of masters to communicate with at least one user.

12. The sports club management system of claim 1, further comprising an E-commerce module, wherein the E-commerce module facilitates purchasing of sports related merchandise to the users.

13. The sports club management system of claim 1, wherein information collected from the plurality of users includes a medical release.

14. The sports club management system of claim 1, further comprising a facilities management module, wherein the facilities management module permits the at least one administrator to schedule practice times and game times at one or more facilities.

15. The sports club management system of claim 14, wherein the facilities management module further permits the at least one administrator to schedule at least one tournament.

16. The sports club management system of claim 15, wherein the facilities management module integrates with the finance module, thereby permitting the at least one administrator to track participation in, and payment for, the at least one tournament.

17. The sports club management system of claim 2, further comprising an equipment management module, wherein the equipment management module tracks equipment owned by or associated with the sports club.

18. The sports club management system of claim 17, wherein the equipment management module further permits the plurality of users to request access to the club equipment.

19. The sports club management system of claim 18, wherein the equipment management module tracks equipment access requests in a waiting list.

20. The sports club management system of claim 17, wherein the equipment management module further permits tracking of equipment owned or associated with each of the plurality of teams.

21. The sports club management system of claim 21, wherein the equipment management module further permits the plurality of users to request access to team equipment.

22. The sports club management system of claim 22, wherein the equipment management module tracks equipment access requests in a waiting list.

23. The sports club management system of claim 5, further comprising an integration module, wherein the integration module monitors statistics stored in the user information to identify talented players and notifies the at least one administrator of the identified players.

24. A sports club management system comprising:
a control panel, wherein the control panel allows at least one administrator to configure settings including at least one sports club name, allows the at least one administrator to define and enter information about a plurality of teams to be a part of the sports club; and permits the at least one administrator to designate at least one user from the plurality of users to serve as coach of each of the at least one teams;
a team information storage module, for storing the team information entered by the at least one administrator;
a registration module, wherein the registration module obtains information from a plurality of users;
a team membership maintenance module, wherein the team membership maintenance module allows the at least one administrator to define which of the plurality of users is assigned to the plurality of teams;
an authentication module, wherein the authentication module permits the at least one administrator and the plurality of users to individually identify themselves to the sports club management system;
a user information storage means, wherein the user information storage means stores the information obtained through the registration module;
a scheduling module, wherein the scheduling module allows the at least one administrator to schedule competitions between at least two of the plurality of teams;
a communications module, wherein the communications module permits the at least one administrator and the plurality of users to communicate;
a finance module, wherein the finance module tracks club financial information, including payment of sports club membership fees by at least one of the plurality of users; and
a training module, wherein the training module provides educational information to at least the plurality of users with respect to at least one sport, wherein the training module provides users with access to a circle of masters.
